(19) United States
(12) Patent Application Publication
(10) Pub. No.: US 2023/0252983 A1
(43) Pub. Date: Aug. 10, 2023

(54) READING DISAMBIGUATION DEVICE, READING DISAMBIGUATION METHOD, AND READING DISAMBIGUATION PROGRAM

(71) Applicant: NIPPON TELEGRAPH AND TELEPHONE CORPORATION, Tokyo (JP)

(72) Inventors: Nozomi KOBAYASHI, Tokyo (JP); Yusuke IJIMA, Tokyo (JP); Junji TOMITA, Tokyo (JP)

(73) Assignee: NIPPON TELEGRAPH AND TELEPHONE CORPORATION, Tokyo (JP)

(21) Appl. No.: 17/608,731

(22) PCT Filed: May 8, 2019
(86) PCT No.: PCT/JP2019/018451

§ 371 Date: Nov. 3, 2021

(51) Int. Cl. G10L 15/22

(52) U.S. Cl. CPC G10L 15/22

(57) ABSTRACT

An input unit receives a morpheme array and parts-of-speech of morphemes of the morpheme array. An ambiguous word candidate acquisition unit (26) acquires, for each morpheme of the morpheme array, based on a notation and a part-of-speech of the morpheme, reading candidates of the morpheme from reading candidates of the morpheme defined in advance for each combination of a notation and a part-of-speech of the morpheme. A disambiguation unit (30) determines a reading of the morpheme from the acquired reading candidates of the morpheme by using a disambiguation rule in which a reading of the morpheme is defined in advance correspondingly to appearance positions of other morphemes and notations, parts-of-speech, or character types of the other morphemes.

### TECHNICAL FIELD

The disclosed technology relates to a reading disambiguation apparatus, a reading disambiguation method, and a reading disambiguation program.

### BACKGROUND ART

In a speech synthesis system required for reading-out and the like, correctly estimating a reading of a word is one of important factors for improving accuracy of the system. Disambiguation of a reading of a word means a task to estimate a correct reading in an input sentence for a word with different readings in the same notation, such as “ [symbol] ” in “ [symbol] (kata) [symbol] [symbol] (I've received things from many people)” and “ [symbol] (hou) [symbol] (I am from the west)”.

As a related-art study on disambiguation of a reading of a word, there is proposed a disambiguation technique characterized by a morpheme notation and an n-gram of a part-of-speech (Ryuichi Yoneda, “Disambiguation of Reading Output by Morphemic Analyzer”, Nara Institute of Science and Technology, Master Thesis, NAIST-IS-MT0151124, 2003).

Further, as a relevant study, a technique for estimating a reading is also proposed and use of an n-gram of characters is featured (Tetsuro Sasada, Shinsuke Mori, and Tatsuya Kawahara, “Improved estimation accuracy of reading with vocabulary acquisition from speech and text”, NLP2008, p. 420-p. 243, 2008).

### SUMMARY OF THE INVENTION

### Technical Problem

As disambiguation of a reading, there are a case (1) and a case (2). The case (1) is a case where words appearing around a word of interest offer a clue. The case (2) is a case where a topic discussed in a sentence in which a word of interest appears (e.g., “baseball”, “Japanese chess”, and the like) offers a clue. For the case (1), a reading of a word of interest can be captured using an n-gram in the related art. However, in morpheme notation and literation used in the related-art technique, for example, “ [symbol] (tsuno) (antler of a deer)” and “ [symbol] (tsuno) (horn of a buffalo)” are different n-grams. Thus, in learning data, even if there is “ [symbol] [symbol] ”, if there is no “ [symbol] ”, it is impossible to correctly estimate “ [symbol] (tsuno)” for the latter, which leads to a problem in that the morphemic notation and the literation cannot cover variations.

In addition, for the case (2), it is theoretically possible to cover variations by setting n to a large value, but there is a problem in that variations cannot be captured in 3-gram and 5-gram used in practical use. For example, in a sentence of “ [symbol] 1 7 [symbol] /4 0 [symbol] / [symbol] (“kyojin” is the name of an organization, and the accent is on “kyo” [symbol] 1/ [symbol] [symbol] ” (Tani of Kyojin, who is in his 17th year as a professional baseball player and 40 years old, plays in the game as the first batter for the first time in this season) (“/” is a boundary of morphemes), if only three to five morphemes before and after “ [symbol] ” are seen, it is difficult to distinguish between a general word “ [symbol] ” and an organization “ [symbol] ”.

The disclosed technology has been made in view of the aforementioned circumstances, and an object thereof is to provide a reading disambiguation apparatus, a reading disambiguation method, and reading disambiguation program that are capable of accurately estimating a reading of each morpheme in a morpheme array.

### Means for Solving the Problem

A first aspect of the present disclosure is a reading disambiguation apparatus, including: an input unit configured to receive a morpheme array and parts-of-speech of morphemes of the morpheme array; an ambiguous word candidate acquisition unit configured to acquire, for each morpheme of the morpheme array, based on a notation and a part-of-speech of the morpheme, reading candidates of the morpheme from reading candidates of the morpheme defined in advance for each combination of a notation and a part-of-speech of the morpheme; and a disambiguation unit configured to determine a reading of the morpheme from the acquired reading candidates of the morpheme using a disambiguation rule in which a reading of the morpheme is defined in advance correspondingly to appearance positions of other morphemes and notations, parts-of-speech, or character types of the other morphemes.

A second aspect of the present disclosure is a reading disambiguation method, including: receiving, by an input unit, a morpheme array and parts-of-speech of morphemes of the morpheme array; acquiring, by an ambiguous word candidate acquisition unit, for each morpheme of the morpheme array, based on a notation and a part-of-speech of the morpheme, reading candidates of the morpheme from reading candidates of the morpheme defined in advance for each combination of a notation and a part-of-speech of the morpheme; and determining, by a disambiguation unit, a reading of the morpheme from the acquired reading candidates of the morpheme using a disambiguation rule in which a reading of the morpheme is defined in advance correspondingly to appearance positions of other morphemes and notations, parts-of-speech, or character types of the other morphemes.

A third aspect of the present disclosure is a reading disambiguation program for causing a computer to execute: receiving a morpheme array and parts-of-speech of morphemes of the morpheme array; acquiring, for each morpheme of the morpheme array, based on a notation and a part-of-speech of the morpheme, reading candidates of the morpheme from reading candidates of the morpheme defined in advance for each combination of a notation and a part-of-speech of the morpheme; and determining a reading of the morpheme from the acquired reading candidates of the morpheme using a disambiguation rule in which a reading of the morpheme is defined in advance correspondingly to appearance positions of other morphemes and notations, parts-of-speech, or character types of the other morphemes.

### Effects of the Invention

According to the disclosed technology, it is possible to accurately estimate a reading of each morpheme of a morpheme array.

### BRIEF DESCRIPTION OF DRAWINGS

FIG. 1 is a schematic block diagram of an example of a computer that functions as a reading disambiguation apparatus according to a present embodiment.

FIG. 2 is a diagram illustrating an example of an input morphemic analysis result.

FIG. 3 is a diagram illustrating an example of an input morphemic analysis result.

FIG. 4 is a block diagram illustrating an example of the reading disambiguation apparatus according to the present embodiment.

FIG. 5 is a diagram illustrating an example of a morphemic analysis result with category information.

FIG. 6 is a diagram illustrating an example of a reading candidate list.

FIG. 7 is a diagram illustrating another example of the reading candidate list.

FIG. 8 is a diagram illustrating an example of a disambiguation rule list.

FIG. 9 is a diagram illustrating an application range of a rule part of a disambiguation rule.

FIG. 10 is a diagram illustrating a condition type of the rule part of the disambiguation rule.

FIG. 11 is a diagram illustrating an example of a disambiguated morphemic analysis result.

FIG. 12 is a diagram illustrating an example of a disambiguated morphemic analysis result.

FIG. 13 is a flowchart illustrating an example of a reading disambiguation processing routine in the reading disambiguation apparatus according to the present embodiment.

### DESCRIPTION OF EMBODIMENTS

Hereinafter, an example of embodiments of the disclosed technology will be described below with reference to the drawings. Note that same reference numerals are assigned to the same or equivalent components and portions in the drawings. In addition, a dimensional proportion in the drawings is exaggerated for convenience of description and may be different from an actual proportion.

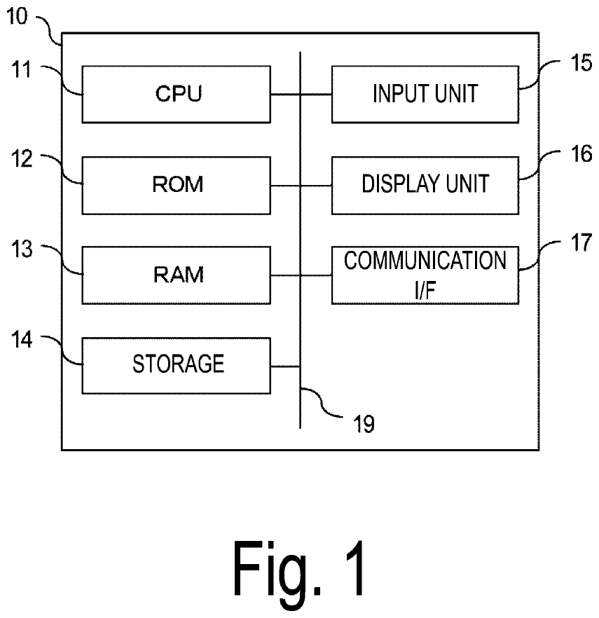

FIG. 1 is a block diagram illustrating a hardware configuration of a reading disambiguation apparatus according to a present embodiment.

As illustrated in FIG. 1, the reading disambiguation apparatus 10 includes a central processing unit (CPU) 11, a read-only memory (ROM) 12, a random access memory (RAM) 13, a storage 14, an input unit 15, a display unit 16, and a communication interface (I/F) 17. The components are communicably connected to each other through a bus 19.

The CPU 11 is a central processing unit that executes various programs and controls each unit. That is, the CPU 11 reads out a program from the ROM 12 or the storage 14 and executes the program using the RAM 13 as a workspace. The CPU 11 performs control and various pieces of processing for each of the above components in accordance with the program stored in the ROM 12 or the storage 14. In the present embodiment, the ROM 12 or the storage 14 stores a reading disambiguation program for disambiguating a reading of an input sentence.

The ROM 12 stores various programs and various data. The RAM 13 temporarily stores programs or data as a workspace. The storage 14 is constituted by a hard disk drive (HDD) or a solid state drive (SSD) and stores various programs including an operating system and various data.

The input unit 15 includes a pointing device such as a mouse and a keyboard, and is used to perform various inputs.

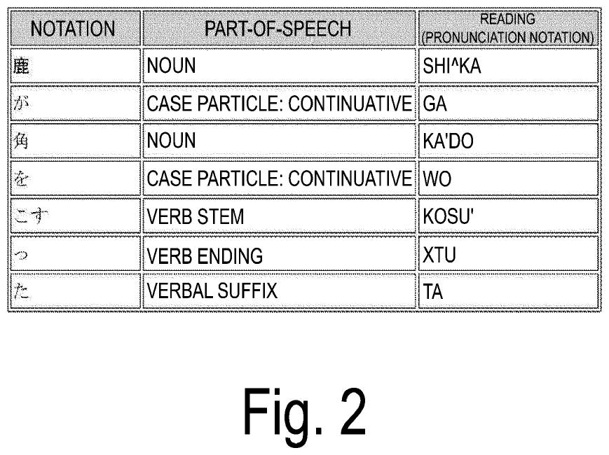

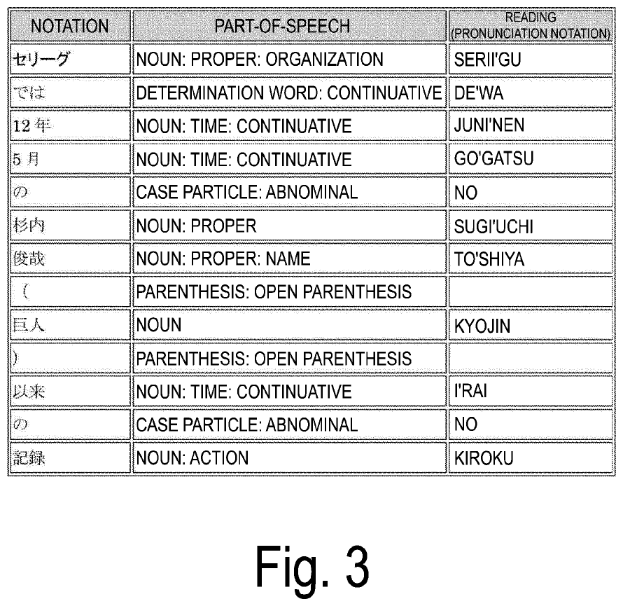

The input in the present embodiment is a morphemic analysis result obtained by analyzing a “sentence” or a “sentence set” that is a morpheme array using a related-art morphemic analyzer, as illustrated in FIGS. 2 and 3. The morphemic analysis result includes at least a “notation”, a “reading (pronunciation notation)”, and a “part-of-speech” information for each morpheme.

The example in FIG. 2 is a morphemic analysis result of a morpheme array “ [symbol] [symbol] (a deer scuffed its antler)” and the example in FIG. 3 is a morphemic analysis result of a morpheme array “ [symbol] 1 2 [symbol] ( [symbol] ) [symbol] (it is the first record in the central league since the record of Toshiya Sugiuchi (of Kyojin) in May 2012)”.

The display unit 16 is, for example, a liquid crystal display, and displays various pieces of information. The display unit 16 may function as the input unit 15 using a touch panel method.

The communication interface 17 is an interface for communication with other devices, and standards such as the Ethernet (trade name), the FDDI, or the Wi-Fi (trade name) are used.

Next, a functional configuration of the reading disambiguation apparatus 10 will be described.

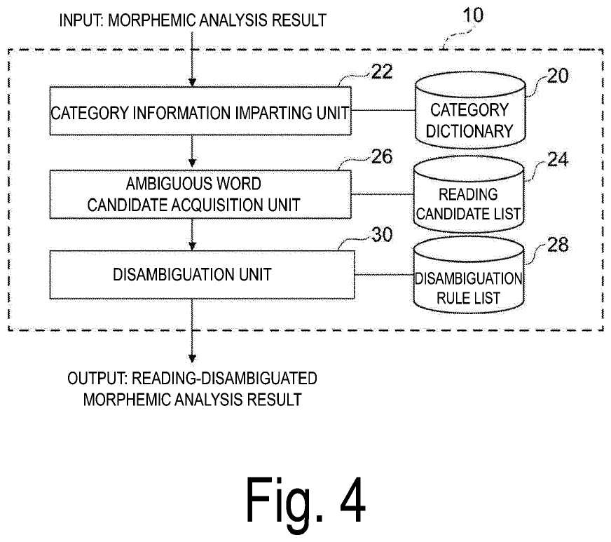

FIG. 4 is a block diagram illustrating an example of the functional configuration of the reading disambiguation apparatus 10.

As illustrated in FIG. 4, the reading disambiguation apparatus 10 has, as functional components, a category dictionary 20, a category information imparting unit 22, a reading candidate list 24, an ambiguous word candidate acquisition unit 26, a disambiguation rule list 28, and a disambiguation unit 30. The CPU 11 reads out a reading disambiguation program stored in the ROM 12 or the storage 14 and expands and executes it in the RAM 13 to realize the respective functional components.

The category dictionary 20 is a dictionary containing category information for a notation of each morpheme and, for example, a “Japanese vocabulary system” can be used.

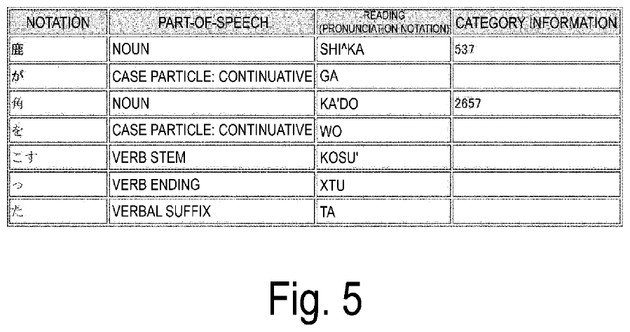

The category information imparting unit 22 uses the category dictionary 20 to impart, to each morpheme of a morpheme array, category information of a word corresponding to the morpheme. Specifically, the category information imparting unit 22 references the category dictionary 20 to output a morphemic analysis result with category information in which category information corresponding to a notation of each morpheme in the input morphemic analysis result is imparted (see FIG. 5).

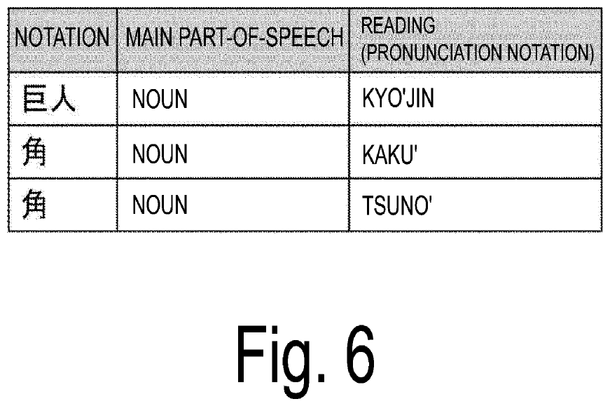

The reading candidate list 24 stores a reading (pronunciation notation) for each of combinations of a notation and a main part-of-speech of each morpheme, as illustrated in FIG. 6. The reading (pronunciation notation) includes “'” which is accent position information. In the example of FIG. 6, for a combination of a notation “ [symbol] ” and a main part-of-speech “noun” of a morpheme, two readings (pronunciation notations), “kaku'” and “tsuno'”, are stored, and the two readings (pronunciation notations) are reading candidates for the combination of the notation “ [symbol] ” and the main part-of-speech “noun” of the morpheme.

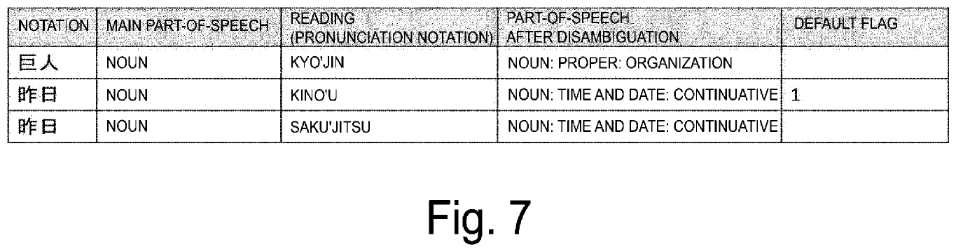

Note that, as illustrated in FIG. 7, for example, the reading candidate list 24 may store, for each of combinations of a notation and a main part-of-speech of each morpheme, information of a part-of-speech to be imparted after disambiguation, flag information indicating that a pronunciation notation is to be imparted as a default when disambiguation is not achieved, and the like, together with a reading (pronunciation notation).

The ambiguous word candidate acquisition unit 26 references the reading candidate list 24 for each morpheme of the input morphemic analysis result, based on a notation and a part-of-speech of the morpheme, to acquire reading candidates of the morpheme.

For example, for each morpheme of the morphemic analysis result, the ambiguous word candidate acquisition unit 26 cuts out only a main part-of-speech from parts-of-speech of the morpheme, searches the reading candidate list 24 for a pair of the “notation” and the “main part-of-speech” of the morpheme, and if there is a fitting pair in the reading candidate list 24, acquires a reading (pronunciation notation) corresponding to the pair as a reading candidate. In the examples of FIGS. 2 and 3 described above, cutting-out of the main part-of-speech is achieved by extracting a first part-of-speech when parts-of-speech are separated with “:”.

For example, in the example of FIG. 3 described above, for a notation “ [symbol] ” of a morpheme, the main part-of-speech “noun” is cut out from the parts-of-speech “noun: proper: organization”, the reading candidate list 24 is searched, and the “ [symbol] kyo'jin” is acquired as a reading candidate.

In the example of FIG. 2 described above, for the notation “ [symbol] ” of a morpheme, the reading candidate list 24 is searched for the part-of-speech “noun”, and “ [symbol] noun kaku'” and “ [symbol] noun tsuno'” are acquired as reading candidates.

The disambiguation rule list 28 stores a disambiguation rule in which for each notation of a morpheme, a reading and a score of the morpheme are defined in advance, correspondingly to appearance positions of other morphemes and notations, parts-of-speech, or categories of the other morphemes.

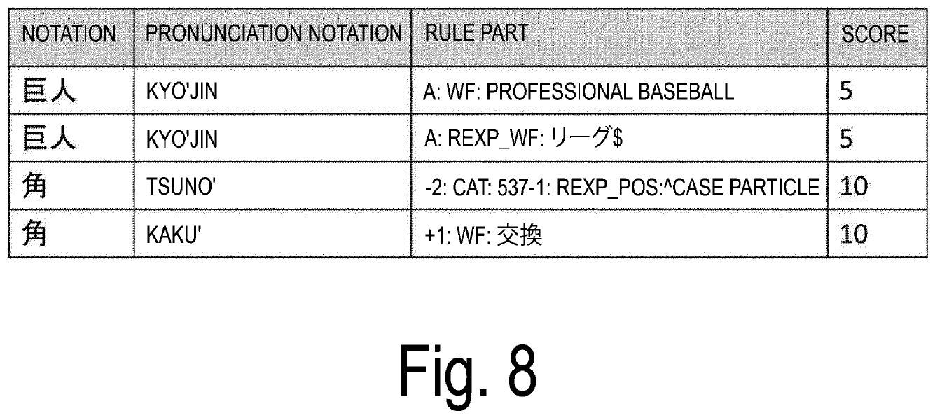

Examples of the disambiguation rule are shown in FIG. 8. The disambiguation rule consists of “notation”, “reading (pronunciation notation)”, “rule part”, and “score”, and the “rule part” further has “condition” including a set of “application range”, “condition type”, and “condition content”. A plurality of “conditions” may be defined in the “rule part” of the disambiguation rule. Note that in the example of FIG. 8, the “application range”, “condition type”, and “condition content” of the rule part are described using “:” as a delimiter character.

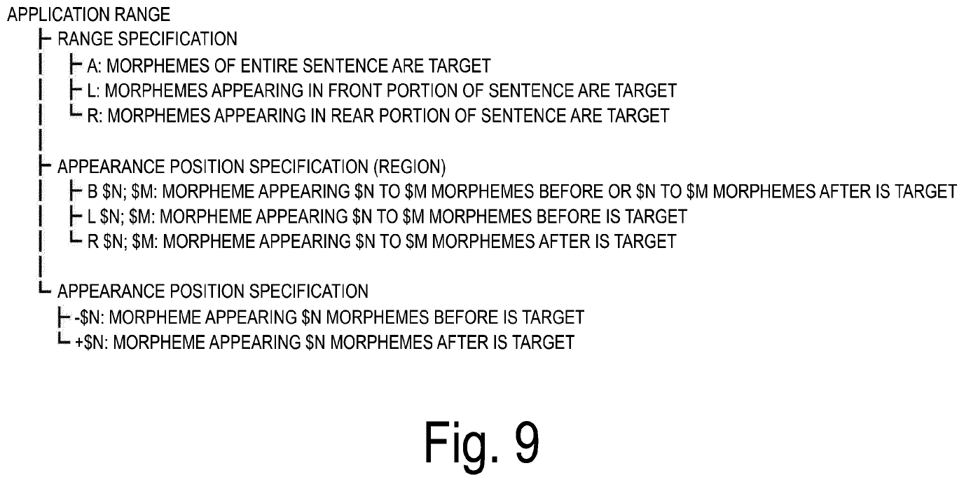

As illustrated in FIG. 9, the “application range” is defined by a range specification, an appearance position specification (range), or an appearance position specification. The range specification is for specifying morphemes of an entire sentence, morphemes appearing in a front portion of the sentence, or morphemes appearing in a rear portion of the sentence as a target. The appearance position specification (range) is for specifying morphemes appearing in a predetermined range in a morpheme array. The appearance position specification is for specifying a morpheme appearing in a forward predetermined position or a morpheme appearing in a rearward predetermined position as a target. Note that the range specification and the appearance position specification (range) are not used in a case where a plurality of conditions are defined.

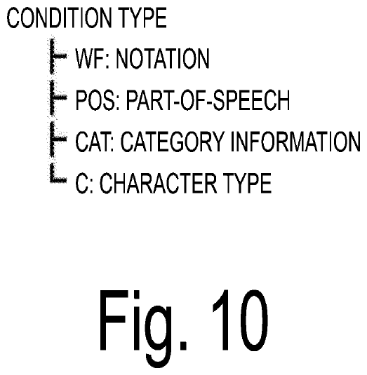

As illustrated in FIG. 10, the “condition type” indicates what type of content a content defined in the “condition content” is related to, and a notation, a part-of-speech, category information, or a character type is specified. In the present embodiment, when “REXP_” is written in the head of the “condition type”, a condition notation is determined to be treated as a regular expression, and when a character type is specified in the “condition type”, the “REXP_” must be always written in the head of the “condition type”.

The “condition content” is a specific value in the type specified in the “condition type”, and when category information is specified in the “condition type”, a category number is specified. When a character type is specified in the “condition type”, a regular expression corresponding to a character type such as a Chinese character, a Japanese hiragana character, a Japanese katakana character, a numeric character, or an alphabetical character is specified in the “condition content”. For example, in a case where the “notation” of the disambiguation rule is “ [symbol] ”, the “reading (pronunciation notation)” is “o”, and “rule part” is “+1: REXP_C: \p{InHiragana}”, if a rule that “a character type of a morpheme notation immediately after the target includes a Japanese hiragana character” is met, it is specified that the “reading (pronunciation notation)” of “ [symbol] ” is determined to be “o”. For example, it is possible to determine the “reading (pronunciation notation)” of “ [symbol] ” of “ [symbol] □” to be “o”.

For each morpheme of the input morphemic analysis result, when the morphemic analysis result for a reading candidate of the morpheme meets a disambiguation rule for the reading candidate, the disambiguation rule being obtained from the disambiguation rule list 28, the disambiguation unit 30 adds a score of the disambiguation rule as a score of the reading candidate. The disambiguation unit 30 determines a reading candidate having the highest score as the reading of the morpheme.

Specifically, the disambiguation unit 30 uses, as a disambiguation target, each morpheme for which there is a reading candidate, compares the morphemic analysis result with category information with the “rule part” of the disambiguation rule for the reading candidate, and if any disambiguation rule is met, a score of the disambiguation rule is added as the score of the reading candidate.

The comparison of the disambiguation rule is performed by checking whether the “condition type” of a morpheme in the “application range” of each condition corresponds to the “condition content.” When a plurality of conditions are present, checking is performed for the individual conditions, and if there is even one condition that a morpheme does not meet, it is determined that the morpheme does not meet the disambiguation rule.

In the case of the example in FIG. 2 described above, “ [symbol] ” is a disambiguation target, and a rule part “-2: CAT: 537 -1: REXP_POS: case particle” of the disambiguation rule is applied to the disambiguation target. This rule part represents that “the category information of a morpheme two morphemes before is 537” and “the part-of-speech of a morpheme one morpheme before is ‘\hat{ }case particle (regular expression representing starting from a case particle)’”. The example of the morphemic analysis result in FIG. 2 described above satisfies this rule part, and thus a score of 10 is added to the pronunciation notation of “tsuno'”.

In the case of the example in FIG. 3 described above, “ [symbol] ” is a disambiguation target, and a rule part “A: REXP_WF: [symbol] $” of the disambiguation rule is applied. This rule part represents that “a notation of any of morphemes in the sentence is ‘ [symbol] $’ (a regular expression representing ending with [symbol] )”. The notation “ [symbol] ” of the head morpheme meets this rule part, and thus a score of 5 is added.

Furthermore, in the case where the “condition type” is the “character type,” for a notation of a morpheme that is a disambiguation target, the comparison of the disambiguation rule is performed by determining whether a regular expression representing the character type specified in the “condition content” is satisfied.

After all of the met disambiguation rules are applied, among readings (pronunciation notations) that are reading candidates, a reading candidate having the highest score is determined to be a reading (pronunciation notation) after disambiguation, and the “reading (pronunciation notation)” field in the input morphemic analysis result is rewritten to the reading (pronunciation notation) after disambiguation. When disambiguation is not achieved, rewriting is not performed. Note that a threshold of the score may be provided and when a score of a reading candidate exceeds the threshold, disambiguation may be determined to be achieved, so that rewriting to the reading candidate may be performed.

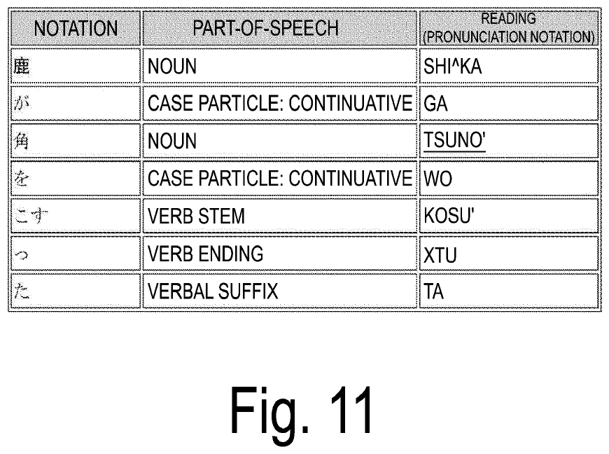

For example, in the example of the morphemic analysis result in FIG. 2 described above, as illustrated in FIG. 11, the reading of “ [symbol] ” is rewritten to “tsuno'” and displayed on the display unit 16 as a reading-disambiguated morphemic analysis result.

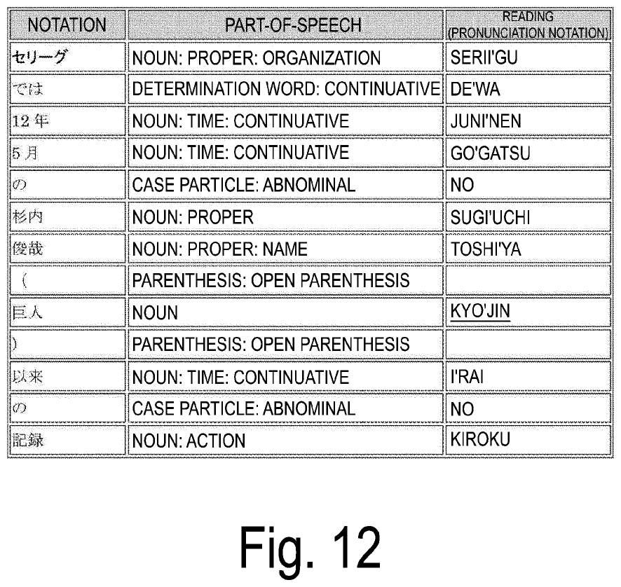

In addition, in the example of FIG. 3 described above, as illustrated in FIG. 12, the reading of “ [symbol] ” is rewritten to “kyo'jin” and displayed on the display unit 16 as a reading-disambiguated morphemic analysis result.

In addition to the “reading (pronunciation notation)” field, the reading candidate list may be made to include parts-of-speech after disambiguation (see FIG. 7) to perform rewriting of the part-of-speech field.

Furthermore, when disambiguation is not achieved by the method using rules described above, or when reading candidates are rejected by the threshold, a “default flag” may be prepared in the reading candidate list to make modification to information of a reading candidate to which the flag is assigned.

Next, an action of the reading disambiguation apparatus 10 will be described.

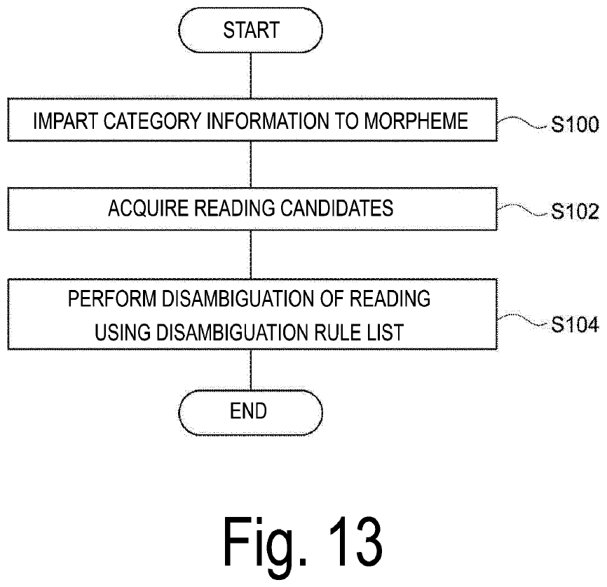

FIG. 13 is a flowchart illustrating reading disambiguation processing performed by the reading disambiguation apparatus. The CPU 11 reads out a reading disambiguation program from the ROM 12 or the storage 14 and expands and executes it in the RAM 13 to perform the reading disambiguation processing.

In step S100, for each morpheme of the morphemic analysis result input by the input unit 15, the CPU 11 uses the category dictionary 20 as the category information imparting unit 22 to impart the category information of a word corresponding to the morpheme.

In step S102, for each morpheme of the input morphemic analysis result, the CPU 11 references the reading candidate list 24 based on a notation and a part-of-speech of the morpheme to acquire reading candidates of the morpheme, as the ambiguous word candidate acquisition unit 26.

In step S104, for each morpheme of the input morphemic analysis result, when the morphemic analysis result for a reading candidate of the morpheme meets the disambiguation rule for the reading candidate obtained from the disambiguation rule list 28, the CPU 11 adds a score of the disambiguation rule as a score of the reading candidate, as the disambiguation unit 30. Then, for each morpheme of the input morphemic analysis result, the CPU 11 determines a reading candidate having the highest score as the reading of the morpheme.

As described above, the reading disambiguation apparatus 10 of the embodiment of the technology of the present disclosure determines a reading of a morpheme from reading candidates of the morpheme using a disambiguation rule in which a reading of the morpheme is defined in advance correspondingly to appearance positions of other morphemes and notations, parts-of-speech, or categories of the other morphemes. This allows for accurate estimation of a reading of each morpheme of a morpheme array included in the morphemic analysis result. In particular, disambiguation of a reading of a word that is an input of speech synthesis can be achieved.

Note that, in each of the above-described embodiments, various processors other than the CPU may execute language processing which the CPU executes by reading software (program). Examples of the processors include a programmable logic device (PLD) such as a field-programmable gate array (FPGA), in which a circuit configuration can be changed after manufacturing, a dedicated electric circuit that is a processor having a circuit configuration specially designed to execute specific processing, such as an application specific integrated circuit (ASIC), and the like. Furthermore, the reading disambiguation processing may be performed in one of these various processors, or in a combination of two or more processors of the same or different types (e.g., a plurality of FPGAs, a combination of a CPU and an FPGA, or the like). Furthermore, the hardware structure of these various processors is, more specifically, an electrical circuit that combines circuit elements such as semiconductor devices.

In the embodiments described above, an aspect has been described in which the reading disambiguation program is stored in advance (installed) in the storage 14, but the present disclosure is not limited thereto. The program may be provided in a form in which the program is included in a non-transitory storage medium such as a compact disk read only memory (CD-ROM), a digital versatile disk read only memory (DVD-ROM), or a universal serial bus (USB) memory. The program may also be in a form in which the program is downloaded from an external device via a network.

In addition, although the case in which the category dictionary 20, the reading candidate list 24, and the disambiguation rule list 28 are present in the reading disambiguation apparatus 10 has been exemplified, the present disclosure is not limited thereto. At least one of the category dictionary 20, the reading candidate list 24, and the disambiguation rule list 28 may be present outside the reading disambiguation apparatus 10.

Furthermore, although the case where the technology of the present disclosure is applied to the reading disambiguation apparatus 10 that rewrites a reading included in the morphemic analysis result, the present disclosure is not limited thereto. For example, the technology of the present disclosure may be applied to an apparatus that uses a morpheme array and a part-of-speech of each morpheme of the morpheme array as inputs to estimate a reading of the morpheme.

With respect to the above embodiments, the following supplements are further disclosed.

Supplement 1

A reading disambiguation apparatus, including:
a memory; and
at least one processor connected to the memory, in which
the processor is configured to:
receive a morpheme array and parts-of-speech of morphemes of the morpheme array; acquire, for each morpheme of the morpheme array, based on a notation and a part-of-speech of the morpheme, reading candidates of the morpheme from reading candidates of the morpheme defined in advance for each combination of a notation and a part-of-speech of the morpheme; and
determine a reading of the morpheme from the acquired reading candidates of the morpheme using a disambiguation rule in which a reading of the morpheme is defined in advance correspondingly to appearance positions of other morphemes and notations, parts-of-speech, or character types of the other morphemes.

Supplement 2

A non-transitory storage medium, storing a reading disambiguation program causing a computer to execute:
receiving a morpheme array and parts-of-speech of morphemes of the morpheme array; acquiring, for each morpheme of the morpheme array, based on a notation and a part-of-speech of the morpheme, reading candidates of the morpheme from reading candidates of the morpheme defined in advance for each combination of a notation and a part-of-speech of the morpheme; and
determining a reading of the morpheme from the acquired reading candidates of the morpheme by using a disambiguation rule in which a reading of the morpheme is defined in advance correspondingly to appearance positions of other morphemes and notations, parts-of-speech, or character types of the other morphemes.

1. A reading disambiguation apparatus, comprising:
an input receiver configured to receive a morpheme array and parts-of-speech of morphemes of the morpheme array;
an ambiguous word candidate acquirer configured to acquire, for each morpheme of the morpheme array, based on a notation and a part-of-speech of the morpheme, reading candidates of the morpheme from reading candidates of the morpheme defined in advance for each combination of a notation and a part-of-speech of the morpheme; and
a determiner configured to determine a reading of the morpheme from the acquired reading candidates of the morpheme using a disambiguation rule in which a reading of the morpheme is defined in advance correspondingly to appearance positions of other morphemes and notations, parts-of-speech, or character types of the other morphemes.

2. The reading disambiguation apparatus according to claim 1, further comprising:
a category imparter unit configured to impart, for each morpheme of the morpheme array, category information of a word corresponding to the morpheme, wherein
the disambiguation rule includes a rule in which a reading of the morpheme is defined in advance correspondingly to appearance positions of the other morphemes and notations, parts-of-speech, character types, or categories of the other morphemes.

3. The reading disambiguation apparatus according to claim 1, wherein
the disambiguation rule includes a rule in which a reading and a score of the morpheme are defined in advance correspondingly to appearance positions of the other morphemes and notations, parts-of-speech, or character types of the other morphemes,
for each of the acquired reading candidates of the morpheme, when the disambiguation rule of the reading candidate is met, the determiner unit adds a score of the disambiguation rule as a score of the reading candidate, and
the reading candidate having a highest score is determined to be a reading of the morpheme.

4. The reading disambiguation apparatus according to claim 1, wherein the reading candidates of the morpheme each include an accent of the reading.

5. A reading disambiguation method, comprising:
receiving, by an input receiver, a morpheme array and parts-of-speech of morphemes of the morpheme array;
acquiring, by an ambiguous word candidate acquirer, for each morpheme of the morpheme array, based on a notation and a part-of-speech of the morpheme, reading candidates of the morpheme from reading candidates of the morpheme defined in advance for each combination of a notation and a part-of-speech of the morpheme; and
determining, by a determiner, a reading of the morpheme from the acquired reading candidates of the morpheme using a disambiguation rule in which a reading of the morpheme is defined in advance correspondingly to appearance positions of other morphemes and notations, parts-of-speech, or character types of the other morphemes.

6. A computer-readable non-transitory recording medium storing computer-executable program instructions that when executed by a processor cause a computer system to:
receive, by an input receiver, a morpheme array and parts-of-speech of morphemes of the morpheme array;
acquire, by an ambiguous word candidate acquirer, for each morpheme of the morpheme array, based on a notation and a part-of-speech of the morpheme, reading candidates of the morpheme from reading candidates of the morpheme defined in advance for each combination of a notation and a part-of-speech of the morpheme; and
determine, by a determiner, a reading of the morpheme from the acquired reading candidates of the morpheme using a disambiguation rule in which a reading of the morpheme is defined in advance correspondingly to appearance positions of other morphemes and notations, parts-of-speech, or character types of the other morphemes.

7. The reading disambiguation apparatus according to claim 2, wherein
the disambiguation rule includes a rule in which a reading and a score of the morpheme are defined in advance correspondingly to appearance positions of the other morphemes and notations, parts-of-speech, or character types of the other morphemes,
for each of the acquired reading candidates of the morpheme, when the disambiguation rule of the reading candidate is met, the determiner adds a score of the disambiguation rule as a score of the reading candidate, and
the reading candidate having a highest score is determined to be a reading of the morpheme.

8. The reading disambiguation apparatus according to claim 2, wherein the reading candidates of the morpheme each include an accent of the reading.

9. The reading disambiguation apparatus according to claim 3, wherein the reading candidates of the morpheme each include an accent of the reading.

10. The reading disambiguation method according to claim 5, further comprising:
imparting, by a category imparter, for each morpheme of the morpheme array, category information of a word corresponding to the morpheme, wherein
the disambiguation rule includes a rule in which a reading of the morpheme is defined in advance correspondingly to appearance positions of the other morphemes and notations, parts-of-speech, character types, or categories of the other morphemes.

11. The reading disambiguation method according to claim 5, wherein
the disambiguation rule includes a rule in which a reading and a score of the morpheme are defined in advance correspondingly to appearance positions of the other morphemes and notations, parts-of-speech, or character types of the other morphemes,
for each of the acquired reading candidates of the morpheme, when the disambiguation rule of the reading candidate is met, the determiner adds a score of the disambiguation rule as a score of the reading candidate, and
the reading candidate having a highest score is determined to be a reading of the morpheme.

12. The reading disambiguation method according to claim 5, wherein the reading candidates of the morpheme each include an accent of the reading.

13. The computer-readable non-transitory recording medium according to claim 6, the computer-executable program instructions when executed further causing the system to:
impart, by a category imparter, for each morpheme of the morpheme array, category information of a word corresponding to the morpheme, wherein
the disambiguation rule includes a rule in which a reading of the morpheme is defined in advance correspondingly to appearance positions of the other morphemes and notations, parts-of-speech, character types, or categories of the other morphemes.

14. The computer-readable non-transitory recording medium according to claim 6, wherein
the disambiguation rule includes a rule in which a reading and a score of the morpheme are defined in advance correspondingly to appearance positions of the other morphemes and notations, parts-of-speech, or character types of the other morphemes,
for each of the acquired reading candidates of the morpheme, when the disambiguation rule of the reading candidate is met, the determiner adds a score of the disambiguation rule as a score of the reading candidate, and
the reading candidate having a highest score is determined to be a reading of the morpheme.

15. The computer-readable non-transitory recording medium according to claim 6, wherein the reading candidates of the morpheme each include an accent of the reading.

16. The reading disambiguation method according to claim 10, wherein
the disambiguation rule includes a rule in which a reading and a score of the morpheme are defined in advance correspondingly to appearance positions of the other morphemes and notations, parts-of-speech, or character types of the other morphemes,
for each of the acquired reading candidates of the morpheme, when the disambiguation rule of the reading candidate is met, the determiner adds a score of the disambiguation rule as a score of the reading candidate, and
the reading candidate having a highest score is determined to be a reading of the morpheme.

17. The reading disambiguation method according to claim 10, wherein the reading candidates of the morpheme each include an accent of the reading.

18. The reading disambiguation method according to claim 11, wherein the reading candidates of the morpheme each include an accent of the reading.

19. The computer-readable non-transitory recording medium according to claim 13, wherein
the disambiguation rule includes a rule in which a reading and a score of the morpheme are defined in advance correspondingly to appearance positions of the other morphemes and notations, parts-of-speech, or character types of the other morphemes,
for each of the acquired reading candidates of the morpheme, when the disambiguation rule of the reading candidate is met, the determiner adds a score of the disambiguation rule as a score of the reading candidate, and
the reading candidate having a highest score is determined to be a reading of the morpheme.

20. The computer-readable non-transitory recording medium according to claim 14, wherein the reading candidates of the morpheme each include an accent of the reading.
